(19) United States
(12) Patent Application Publication
(10) Pub. No.: US 2019/0158275 A1
(43) Pub. Date: May 23, 2019

(54) DIGITAL CONTAINERS FOR SMART CONTRACTS

(71) Applicant: Michael Beck, New York, NY (US)

(72) Inventor: Michael Beck, New York, NY (US)

(21) Appl. No.: 16/198,177

(22) Filed: Nov. 21, 2018

Related U.S. Application Data
(60) Provisional application No. 62/589,971, filed on Nov. 22, 2017.

(51) Int. Cl. H04L 9/06; H04L 29/06; G06F 16/23; G06F 16/27; H04L 9/08; G06Q 20/38; G06Q 20/06

(52) U.S. Cl. CPC H04L 9/0637; H04L 63/20; G06F 16/2379; G06F 16/27; G06Q 2220/00; G06Q 20/3829; G06Q 20/0658; H04L 2209/38; H04L 2209/56; H04L 9/0861

(57) ABSTRACT

Data characterizing a first access policy for a first digital attestation including data characterizing an attestation affecting an execution of a smart contract can be received. The first digital attestation can be encrypted and packaged into a first digital attestation container. Data characterizing a first request for access to the first digital attestation container can be received by an attestation clearing service. The first request can include a first recipient, and the first recipient can include a first recipient identifier. Access to the first digital attestation container for the first recipient can be determined by the attestation clearing service. The determining can include comparing the first recipient identifier to first access policy. Access to the first digital attestation container can be provided to the first recipient by the attestation clearing service. Related apparatus, systems, techniques and articles are also described.

### RELATED APPLICATION

This application claims priority under 35 U.S.C. § 119(e) to U.S. Provisional Patent Application No. 62/589,971, filed Nov. 22, 2017, and entitled “Use of Digital Containers as a Mechanism for Ensuring and Attesting to the State Data used by Smart Contracts”, the entire contents of which is hereby expressly incorporated by reference herein.

### TECHNICAL FIELD

The subject matter described herein relates to distributed computing systems.

### BACKGROUND

Blockchains can be used to facilitate the development of distributed ledgers. A distributed ledger can include multiple parties connected in a peer-to-peer network. The parties can use consensus to create a verified, immutable, representation of transaction data in an environment where trust between the parties can be limited. In the development of distributed ledger technology, a number of different consensus mechanisms can be used, including Proof of Work and Proof of Stake, whereby ledger balances can be used as an incentive mechanism to enforce the correct behavior of the network participants charged with maintaining the ledger.

### SUMMARY

In an aspect, data characterizing a first access policy for a first digital attestation including data characterizing an attestation affecting an execution of a smart contract can be received. The first digital attestation can be encrypted and packaged into a first digital attestation container. Data characterizing a first request for access to the first digital attestation container can be received by an attestation clearing service. The first request can include a first recipient, and the first recipient can include a first recipient identifier. Access to the first digital attestation container for the first recipient can be determined by the attestation clearing service. The determining can include comparing the first recipient identifier to first access policy. Access to the first digital attestation container can be provided to the first recipient by the attestation clearing service.

One or more of the following features can be included in any feasible combination. For example, data characterizing a first smart contract transaction can be received by the attestation clearing service. The first smart contract transaction can be encrypted and packaged into the first digital attestation container by the attestation clearing service. A first decryption symmetric key for decrypting the first digital attestation container can be generated by the attestation clearing service. The first decryption symmetric key can be provided by the attestation clearing service. The encrypting and packaging of the first smart contract transaction can include utilizing a public credential of the attestation clearing service. The smart contract can include a transaction protocol that executes at least one term of a contract. The first digital attestation container can include a digital cryptocurrency unit of exchange, a metadata, an associated cryptocurrency address, a keys, a structured data, and/or an unstructured data. The first access policy can include data characterizing an authorization criteria for access to the first digital attestation container. The authorization criteria can include a user context, an execution context, an application context, a data context, a passcode, a claim id, a geo-fenced location of attempted access, and/or a geo-grided location of attempted access. The attestation clearing service can include a decentralized clearing environment, and can include a plurality of clearing machines that can be configured to determine access to the first digital attestation container. The determining can include a coordinated consensus between the plurality of clearing machines. The attestation can include bearing witness, confirming, authenticating, validating, verifying, and/or documenting.

In another aspect, a system can include a building service and a tournament service. The building service can be configured to receive data characterizing a first access policy. The first access policy can be for a first digital attestation. The first digital attestation can include data characterizing an attestation affecting an execution of a smart contract. The building service can be configured to encrypt and package the first digital attestation into a first digital attestation container. The attestation clearing service can be configured to receive data characterizing a first request for access to the first digital attestation container. The first request can include a first recipient. The first recipient can include a first recipient identifier. The attestation clearing service can determine access to the first digital attestation container for the first recipient. The determining can include comparing the first recipient identifier to the first access policy. The attestation clearing service can be configured to provide, to the first recipient, access to the first digital attestation container.

One or more of the following features can be included in any feasible combination. The attestation server can be configured to receive data characterizing a first smart contract transaction, encrypt and package the first smart contract transaction into the first digital attestation container, generate a first decryption symmetric key for decrypting the first digital attestation container, provide the first decryption symmetric key. The encrypting and packaging of the first smart contract transaction can include utilizing a public credential of the attestation clearing service. The smart contract can include a transaction protocol that executes at least one term of a contract. The first digital attestation container can include a digital cryptocurrency unit of exchange, a metadata, an associated cryptocurrency address, a keys, a structured data, and/or an unstructured data. The first access policy can include data characterizing an authorization criteria for access to the first digital attestation container. The attestation clearing service can include a decentralized clearing environment that can include a plurality of clearing machines that can be configured to determine access to the first digital attestation container. The determining can include a coordinated consensus between the plurality of clearing machines. The attestation includes bearing witness, confirming, authenticating, validating, verifying, and/or documenting.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating an operating environment according to an implementation of the current subject matter; and

FIG. 2 is a process flow diagram illustrating a method according to an implementation of the current subject matter.

Like reference symbols in the various drawings indicate like elements.

### DETAILED DESCRIPTION

In Proof of Work consensus, network participants can compete on the basis of computing power. Submitted transactions can be captured by network participants who can solve difficult problems supported by the iterative execution of cryptographic functions. The captured transactions can be appended into blocks that can be subsequently appended to the blocks of previous consensus activities of the network.

In Proof of Stake consensus, participants with larger balances can be trusted to perform the computational process and the complexity and power consumption of Proof of Work consensus can be avoided. Other approaches to consensus can include the use of scheduling and verification, including Delegated Byzantine Fault Tolerance, where ledger maintenance can be scheduled between nodes, and the result can be voted as accurate by a percentage of the other network participants. In these cases rewards from the creation of the block, either associated with scheduled block awards based on complexity or miner allocations submitted as part of the transactions themselves, can be collected and shared between network participants.

In addition to the aggregation of transaction data, some networks that implement distributed ledgers using blockchains can provide for the execution of Turing-complete logic. These “smart contracts” can provide additional logic to the task of ledger assignment between counterparties on a cryptocurrency ledger, which can be executed by the distributed ledger network in the process of capturing and appending that data. On the networks smart contracts are executing on, they can provide for conditional assignment on the basis of other state conditions. In other environments that can require verification for successful verification, they can provide for conditional assignment on the basis of real-world state that can require additional evidence for successful verification.

While a smart contract can verify state conditions that involve time (e.g., assign cryptocurrency on the present ledger after a given date) or balance (e.g., unlock currency due for assignment to another address when the cumulative balance due to a given account is in excess of a specific amount), other real-world conditions can be harder to verify. Real-world conditions can include verifications based on real-world parameters. For example, verification can be based on things such as a stock price, a temperature, and/or a party completing a specific task as can be contemplated by a legal agreement. For these things, the smart contracts, which can execute in a decentralized environment, can rely on evidence queried from a defined source, which can be a centralized or decentralized actor with authority to inform the smart contract's execution. These actors can be called “Oracles.”

Oracles can be recognized by the author of the smart contract at the time the smart contract is authored. They can be the authoritative sources against which the smart contract can seek to verify the success criteria for the performance of a ledger operation to complete as anticipated by the parties for whom the smart contract can be relevant. With an ever increasing and diverse amount of commerce being migrated to distributed ledger systems, the use of smart contracts is increasing, as is the importance of validation and verification of the determinants through which they may execute. Oracles can become increasingly more important, and security around these systems and the data they communicate can stand to have real transactional value and impact in global commerce.

Like some centralized data environments, some Oracle environments can be secured against a number of potential attacks. These attacks can originate from both internal and external constituents, and can attack against network, infrastructure, and/or the underlying data itself. The attacks can be problematic, and a number of technical solutions can prevent tampering and ensure the integrity of these systems. Given the increasing significance of Oracles, attacks directed at the availability of the Oracles (e.g., denial of service and/or other attacks against the Oracles) at the time a smart contract can require their services can pose great risk. Poor availability of these services, for example, as a result of malicious attacks or poor reliability of the core Oracle service, can pose a problem for smart contracts in that without availability, the smart contracts entered, cannot be executed. Moreover, an Oracle recognizing its interest or desire to block the execution of a specific transaction can deny required attestation that has been contemplated to either extort greater value from the smart contract parties or otherwise deny access to data altogether

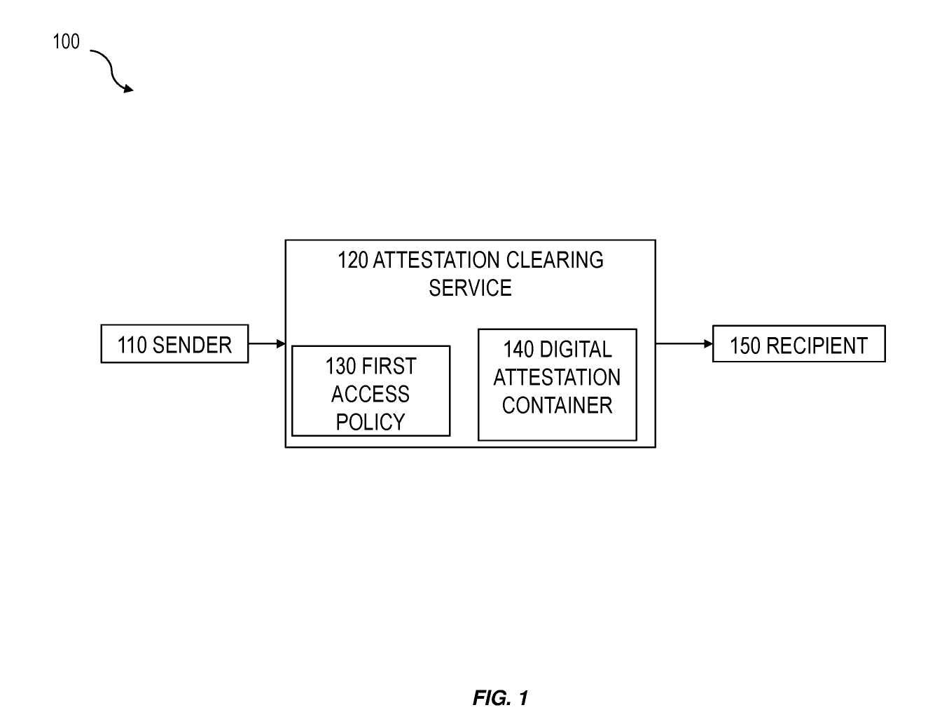

FIG. 1 is a system block diagram of an operating environment according to an implementation of the current subject matter. In some implantations, Sender 110 can transmit a digital attestation to Attestation Clearing Service 120 (e.g., digital attestation container clearing service). Attestation Clearing Service 120 can receive the transmitted digital attestation, and can also receive First Access Policy 130 corresponding to the digital attestation. Attestation Clearing Service 120 can generate Digital Attestation Container 140, and can transmit Digital Attestation Container 140 to Sender 110. Sender 110 can transmit Digital Attestation Container 140 to Recipient 150.

The current subject matter includes techniques that can support the development of systems that can provide a secure mechanism for asynchronous, or, alternatively, out-of-band, attestation to the occurrence of real-world events, as can be required by the execution of smart contracts on a public or private blockchain. In such an approach, the Oracle (or “Sender”) can be a person or computer-bound process that can observe the real-world event. It can package data representing its attestation and supporting materials (a “Digital Attestation” or “DA”) in an encrypted content holder, referenced herein as a Digital Attestation Container (“DAC”).

Access to the DAC can be managed using a clearing mechanism (the “DAC Clearing Service”) that can be informed by access policies that can be specified either before or after packaging the content, such that these policies can be used by the clearing mechanism to approve or deny a request that results in the DA's availability being made to a Recipient. These policies can be created or modified by the Oracle, an intermediary, and/or other agreed upon party after the DAC can be distributed, and can be created or modified without repackaging or redistributing the DA contained in the DAC. The rights and access of Recipients to the DAC can be managed, and ultimate Recipients can be known or unknown to the Sender at time of distribution. As the DAC can be demonstrated to be valid and the DA packaged within can be demonstrated as authentic, a Recipient can participate as an intermediary or can provide the DAC to subsequent Recipients without the need for generating a broader DA transaction history.

The current subject matter can provide mechanisms for specifying, delegating, and enforcing the assignment of Digital Attestations (“DAs”) as they are generated by Oracles and other Senders and can be used by smart contracts and other potential Recipients and interested parties. For example, in a DA exchange, a Sender can present the DA to the current subject matter and receive, in return, a Digital Attestation Container (“DAC”) that may be freely distributed to a Recipient, who at time of receipt can use the DAC to enable a smart contract-based or physical world activity.

The current subject matter can use a Rights Managed Container to allow the Sender of a DA to address a known or unknown Recipient. Digital Rights Management (DRM) Containers can be used for the purpose of distributing content to end users, where control over access and activities that can be performed with respect to that content can be continuously controlled. In the example of distributing music, DRM can prevent music that has been serialized to a specific device from being played on another device. For enterprise document management and distribution, DRM can ensure than content cannot be viewed, printed, or copied without the sender's explicit permission.

By utilizing a DRM Container to transfer DA's, the ownership of the DA and its value can become a single portable unit, which can be passed in a controlled manner from Sender to Recipient without reliance on centralized audit mechanisms or availability typical of other DA implementations. For example, transactions need not be universally visible and mined to by the requisite distributed ledger (e.g., smart contract execution on a blockchain) to be assured of receipt or verified as accurate until the time they are required by the Recipient for a subsequent transaction involving synchronization with and execution on the desired distributed ledger. Add the notions of late-bound terms and conditions to that DRM container and the ability to use Recipient role and context to determine how and when the container is accessed, such that its associated DA can be processed by a Recipient's requisite process, and new flexibilities arise with respect to traditional use and venue for DAs. In such an approach, the anonymity and security of transactions can be better realized, without availability concerns or attacks that may come from an Oracle in the case of identifiable transactions.

In addition to providing for availability to the role provided by the Oracle, the smart contract may also have long-term attestation issues. As smart contracts execute against their respective ledgers, it can be important to link into traditional layers of business accountability and risk management. Among these layers can be providing evidence of the certified execution state of a smart contract as it relates to the assignment of value or other outcome. In the real world, attestation can provide necessary support for activities governed by insurance to protect against risk. For example, Errors and Omissions insurance policies can be used by businesses to protect them from risk. The executing host of a node on a distributed or centralized network, which can be tasked with performing the outcome of a smart contract, can find the non-reputable recording of smart contract execution state to be a helpful artifact. Artifacts of this type can be written to other ledgers and can be submitted to other distributed ledgers (e.g.: blockchains) for storage or processing. Using the DA format can provide a mechanism whereby the contents of the transaction can be sealed from third-party observers who can otherwise have interest in trading against the success of outcomes.

Some implementations of the current subject matter can include three parts: 1) A Secure Container Structure, the DA Container (“DAC”); 2) A Mechanism for Flexibly Storing Preferences Regarding DAC Assignment; and 3) Components for the Distributed Packaging, Issuing, Clearing, Accessing, and Managing DA Assignment Transactions.

Furthermore, in some implementations, the following properties of the current subject matter can be exhibited: no requirement that the Sender or Recipient be known to the system components or have a direct relationship with each other; no requirement that an intended Recipient(s) at the time of DAC packaging; no requirement for established trust to ensure subsequent access and transfer of value from the DAC package between Sender and Recipient; no requirement for the centralized management of Sender or Recipient identity, but aspects of identity and identity management may be further introduced to the current subject matter to provide additional levels of surety and trust in the communication of DAs.

Furthermore, established transactions involving the use of DA can be allowed to be recalled by the Sender at any point prior to the DA being accessed by the Recipient resulting in the execution of a smart contract for which it may be applied, which can create a custody state in addition to an assignment state, whereby the full control of the DA can be realized by a Recipient, but can be pending assignment that can still be managed by the Sender. This notion can contribute to the improvement of Oracle availability, for example, by blinding the Oracle to the specific production and use of its data, while also reducing reliance on the Oracle's real-time availability by permitting asynchronous adjudication against Oracle-produced data by a smart contract.

With respect to the Digital Attestation Container (DAC) Structure, data communicated to users of the current subject matter can be stored in a secure, rights managed container, whose structure can be specified in either a programmatic or declarative format. This format can be used by a programmatic subsystem that encrypts data to generate a secure Digital Attestation Container (DAC).

Data, or content, that can be encrypted can include, but is not limited to, digital cryptocurrency units of exchange, metadata, associated cryptocurrency addresses, keys, structured and unstructured data that may be retrieved from one or more Oracles that are party to a smart contract transaction, and/or other supporting content for transmission between a Sender and Recipient. During the generation of the DAC by a DAC Generator, data, or content, can be encrypted, with explicit terms and conditions for use, into specified secure digital attestation content holdings (DACH). These DACHs can use their own symmetric key to decrypt their respective content. Each DACH symmetric key can be encrypted using the public credentials of one or more DAC Clearing Services and can be packaged with the encrypted content. During the clearing process, the contents of the encrypted DACH and symmetric key can be sent by the DAC Recipient using a trusted client application to a DAC Clearing Service such that context and credentials of the Recipient can be used in the determination of whether the DAC Clearing Services should grant access to the requested holding. The decision to grant access to the holding can result in the decryption of the holding using its encased symmetric keys and re-encryption with a session specific key that can permit the Recipient limited use of the holding content within a trusted environment, such that they can witness or alternatively process on the basis of digital attestation.

One or more DA can be represented by a single DAC. If more than one DA is represented by a single DAC, the digital attestation content holdings can be independently encrypted. As such, the DAC can be highly customized for specific applications such as packaging and communication of bulk attestations, or providing attestations that can only be accessed at different times. Furthermore, content can be communicated between a trusted Client application and the Clearing Services and the DAC can be delivered using various methods of distribution (e.g., email, Internet, private network, portable device, removable storage, and/or the like) without breaking the underlying security model.

This approach for securing DA can be tamper-resistant, and, depending on key strengths used for encryption, can be tamper proof. The DAC format can be structured in a way that: 1) Various types of pluggable encryption algorithms can be used to secure DA content; 2) Credentialing and PKI technology can be used to validate DAC Recipients such that they can extract or can otherwise use DAC content for the adjudication of their smart contract processes or, alternatively, can provide attestation to the outcome of the smart contract process or processes that have had their artifacts stored to the DAC; 3) Digital signatures and message digests over encrypted DACH can assure End Users and executing smart contracts that content can be genuine and cannot have been tampered with; 4) Packaged content can be validated and presented as authentic at the time when the DAC is opened at the trusted client application.

For digital attestation application, metadata within a DAC can provide a structure such that the DAC can be searched without compromising the safety or security of the DA or the outcome of the smart contract to which the DAC attests. Additional metadata can be added to enhance processing capabilities at the time of clearing or by smart contract contracts.

Rights Management Specification can be the specification data used by the DAC Generation Services to build a DAC. The Specification can contain information such that the Recipient Client can know the location of the relevant DAC Clearing Services or supporting network, and can specify the roles and credentials that are eligible for requesting DAs, in addition to fees that can be applicable and required for access. Packaging metadata, including that regarding the DAC Issuer (builder) and general identification number can be overloaded in the payload used for clearing the DAC such that it can be used in determining user specified restrictions over the content that may not embedded in the terms and conditions of a requested holding. Requests for a DAC DACH access can be configurable and logged by the DAC Clearing Services to facilitate account auditing and reporting. Transactions can be anonymized with respect to Sender, Recipient, and/or both. Auditing can reflect the attempts to access the DAC under anonymous transaction conditions, and the final clearing that can permit the access to the DA. Once a DACH's DAC has been accessed, the rights management specification used to structure the DAC can be used conjunction with the DAC Clearing Services and can render the DACH ineligible for subsequent clearing.

With respect to a mechanism for flexibly storing preferences regarding DA access, the mechanism used for storing and identifying Sender preferences regarding content access can be defined by three different semantic structures: Articulation of Digital Attestation Container (DAC) Structure, Articulation of the DAC Sender relationship to Recipients (if applicable); and Articulation of the DAC Sender preferences.

With respect to Articulation of Digital Attestation Container (DAC) Structure, packaging descriptions for the DAC can be used by the current subject matter, and can keep track of the DAC issued and its supporting structure. This DAC structure can be specified in terms of: Digital Attestation Container (DAC); Digital Attestation (DA); and Digital Attestation Content Holdings (DACH).

With respect to Digital Attestation Container (DAC), the DAC has the structure articulated above. It can be referred to by one or more of the following: a unique name, a unique generated identifier, a DAC Issuer (or DAC Generation Services), and, alternatively, in a non-anonymous distribution scenario, the DAC Sender. The generated identifier, which can be non-sequential, can be used for the purpose of cataloging, management, control and/or audit by the Current subject matter.

Some implementations of the current subject matter can be specified as the DAC Issuer for purposes of aggregating or publishing the DAC to intended Recipients for further distribution and use: DAC metadata can provide information about the aggregate value and DA type of DAs stored in the DAC. For example, the value of the DAC can be ascertained without live connection to the DAC Clearing Services. The DAC can store information regarding one or more DAC Clearing Services where its content can be decrypted. In cases where the DAC metadata does not contain this information, the information can be bound to the description of the DAC holding to which access is being requested or as part of the encrypted content of the DAC holding. In such cases, a Recipient can provide context or credentials to decrypt the type information as part of the DACH, and can provide them independently or as part of their request to access the DAC related content.

The DAC can allow for release/delivery of metadata related to the DA, while keeping the attestation content user conditional access with conditions specified by the Sender. The DAC can hold only private data necessary for decrypting, proving (e.g., supporting zero-knowledge proofs), or can legitimize publicly available DAs communicated in another fashion or in a separate DAC. One benefit of this can be that the DAC can be released to an intended Recipient and the attestation it can offer can be issued contingent to subsequent agreement, activity, and/or other conditions including the execution of a monetary payment or state of a distributed ledger (e.g.: a blockchain). These conditions can be verified through integration between the DAC Clearing Services and the distributed ledger it is tasked with observing.

With respect to DAC Security, the DAC can be a self-contained container consisting of content providing attestation to data that can be provided by one or more Oracles to a decentralized network and/or the execution of one or smart contracts. Within the DAC, the data can be used to provide attestation and other related components, and can be stored and encrypted using a one-time generated symmetric key. In turn, the data can be encrypted using the public credentials associated with one or more Clearing Service environments, in support of an asymmetric cryptographic operation that can require the use of private credentials for reassignment given successful authentication and authorization of a Recipient. As a result, the contents of the DAC can be compound encrypted. The DAC's metadata can be alternately encrypted, but it can be assumed that the security of this metadata, absent specific details regarding the digital attestation and status of approval or denial of smart contract execution, provided therein, may not be as sensitive as the rest of the DAC contents.

With respect to DAC Deterrence, an attacker can attempt to decrypt the DAC via brute force to obtain information associated with the Digital Attestation, for example, as part of a scheme to front-run or otherwise interrupt or profit from information that has yet to be exposed to a given smart contract. This can be an issue if the attestation has not already been used to facilitate a smart contract execution, such that the status of the smart contract's outcome is not already public. This said, a more recent attestation can be provided by either a smart contract or Oracle, and can serve as having more value than an attestation of questionable provenance obtained by an intervening third-party to an intended Recipient.

With respect to Digital Attestation, a Digital Attestation (DA) can be private or public information required to be shared with an intended recipient to affect the execution of a smart contract or attest to the data used in the adjudication of a smart contract that was used in deriving its outcome. This can include, for example, a copy of data outputs and calculations provided by supporting Oracles and smart contracts, timestamps, signatures/certificates/keys associated with the data exchange, and can also include additional trusted metadata or attributes associated with the results from related Oracle or smart contract activity used in the exchange that should only be accessed by the DA recipient. This information can captured, for example, in an XML or JSON structured content format, but can be incorporated using, for example, an RFC 822 file format or other structured/unstructured data approach, for incorporation into the DAC.

With respect to Digital Attestation Content Holdings (DACH), DACH can be uniquely encrypted collections of content and associated terms and conditions stored in the aggregate form of a DAC. A DACH can hold one or more pieces of content that can be released to control of Trusted Client, for example, for an authorized request to the Clearing Services to allow for the decryption of data associated directly with the Digital Attestation being provided. DACHs can be considered authorized for access by parties, other than a Recipient, who can meet a Sender's criteria for DA access, but in these cases, all of the data necessary to verify or validate the Digital Attestation may not be available for decryption. For example, this can be performed by mirroring the DACH with a holding that only includes metadata content.

With respect to articulation of DAC sender's relationship to recipient (if applicable), some implementations of the current subject matter can be deployed in fully trusted environments, where both the Senders and the Recipients of DACs have known and verifiable identities. Some implementations of the current subject matter can also be deployed where Senders and Recipients of DACs are unknown, for example, to the current subject matter or each other, and where knowledge of either Sender or Recipient identity can be asymmetric (e.g., Sender identifiable to system or Recipient identifiable to system).

If a Recipient performs a transaction with a DA received as a result of being party to the current subject matter, and that transaction is subject to Anti-Money Laundering/Know Your Customer (“AML/KYC”) processes, the Recipient's anonymity can be compromised, but only within scope of the party performing AML/KYC, as the Recipient's identity is never formally reported to the current subject matter's transaction processing log. Therefore, while the specifics of the Digital Attestation can become identifiable through the AML/KYC process, anonymity of the Recipient, and the anonymity of having received the DA from a Sender can be preserved.

While the current subject matter does not require the centralized management of Sender or Recipient identity, aspects of identity and identity management can be layered in, and can provide additional levels of surety and trust in the communication of DAs. To elaborate, an account with a traditional username, password or other credentials can be used (e.g., nothing about the Senders of Das need be established with respect to their identity). In an implementation, the Sender can submit the content of the Digital Attestation to the current subject matter, and in return, can receive an identifier generated by the current subject matter. This identifier can be used to subsequently manage the DAC that has been created. At a level of additional certainty, the generated identifier can be used in conjunction with an established set of non-specific Oracle or smart contract identifiers, for example, computer IP or MAC address, sending device geolocation, and/or time of day, and can determine control parameters over the distributed DAC. With specific Oracle or smart contract credentials, for example, usernames and passwords or email addresses added to the current subject matter, user focused management of all DAC generated by the Sender can be allowed. In addition, generated DAC identifiers can be recovered. A Sender, who can be a human, can also provide content required for a DAC to either an Oracle, smart contract or another human as a recipient. Alternatively, they can serve as a Publisher for a DAC that has been obtained by another Sender, who can be identified as an Information Owner, and can facilitate the distribution or availability of the DAC. Information Owners and Publishers can also be smart contracts or Oracles.

A Recipient, who can be a person, system, or process, including an Oracle or smart contract, can receive access to the content of the DAC without being explicitly known to the current subject matter. Upon receiving the DAC, the DA Recipient's Trusted Client can connect with the current subject matter, and can provide, for example, the user or (in the case of a requesting smart contract or Oracle) execution context, application context, and data context (information about the DAC being opened). The criteria for the accessing the DAC can be non-specific to Recipient and criteria for releasing the content of the DAC can be satisfied by application context and non-specific parameters, for example, a potential passcode/claim id, geo-fenced or geo-grided location of attempted access. The Recipient can claim the DA without being known to the Sender.

A DAC can be given to multiple parties, each of whom can verify that the DAC and its enclosed attestations are valid. Upon an agreed condition, the Sender can enable the DAC for one Recipient and can disable the distributed DACs in possession of the others. Because multiple DACs can be freely distributed (even to a public directory) it can be difficult to identify the intended Recipient until the point where they apply the DA to a transaction that can compromise their anonymity, such as an AML/KYC process. In a distributed network, multiple copies of the same DAC can be used to allow nodes to independently verify the determinations of any single node that can be tasked with smart contract execution without independent query of the specified Oracle.

Within the current subject matter, the criteria for approval of Recipient access can be expressed in a single table structure that can optionally reference a record of the Recipient as an identified user in the system. The table can relate, for example, the system identifier of the DAC, an identifier of the DACH, the contextual access type that is enabled (e.g.: LOCATION, TIME, PASSCODE), the qualified parameter by which the rule is established as true (e.g. BEFORE, AFTER, EQUALS, WITHIN), the value of the parameter for testing qualification (e.g. 10 am, 10 pm, “secret”, 10 miles of lat/lng), whether it is qualified as a AND (“&&”) or an OR (“∥”) condition, and if it is grouped in evaluation with other rules expressed. Multiple rules on a holding's access can be considered additive by a logical AND operation, unless otherwise specified. In some implementations, basic expressions can be structured for processing, for example, allowing concepts such as the following to be expressed: (RULE 1 && RULE 2 && RULE 3)∥RULE 4, (RULE 1 && RULE 2) && (RULE 3∥ RULE 4), (RULE 1 && RULE 2)∥(RULE 3 && RULE 4).

With respect to Sender and Recipient are Known To Current subject matter, all eligible Senders and Recipients can have an account with the Current subject matter, where they can have been credentialed such that they can be authorized to access the system (e.g.: using passwords, PKI, One-time-password, and/or the like). Eligible Senders and Recipients can include people, but can also include Oracles and smart contracts. In the case of an Oracle, the Oracle can address the functionality of the current subject matter, for example, using an API key or via an account that can reflect agency over the Oracle by specific group or individual user. In the case of a smart contract, an identifier can be established by the smart contract author that can provide for unique API access to generate or otherwise access received DACs. The author of a calling smart contract Senders can invite Recipients to use the current subject matter. Sender and Recipient credentials can be stored in a variety of storage, for example, a datastore repository (e.g.: relational database, NOSQL datastore), a lightweight directory (e.g. LDAP), a flat file, and/or the like.

Senders, including those working on behalf of an Oracle or smart contract, can identify intended Recipients for DA from a common directory, and can specify additional conditions, for example, a shared password, location for retrieval, time and date for retrieval, and/or other conditions that can be used in consideration by the current subject matter in considering the transfer of the DA to the intended Recipient.

The Recipient can be optionally notified of DAC creation. The Recipient can receive the DAC, for example, as an attachment to an email communication from the current subject matter. The Recipient can receive an invitation to retrieve the DAC from a private retrieval area within the scope of the current subject matter, for example, a private messaging system or ‘Inbox’. The Sender can alternatively retrieve the DAC from the current subject matter and can provide the DAC to the Recipient, for example, as an attachment to email, on removable medium, on publicly hosted file sharing site, and/or by other means. The Sender can track the successful receipt of the DAC and opening of the DAC.

With respect to when Sender and Recipient are unknown to current subject matter, both Sender and Recipient can be unknown, which can be advertisement sponsored or otherwise supported within a closed community through which a collection of DACs can be cataloged and retrieved using an interface that can perform, for example, canned or ad hoc query and/or queries on the basis of DAC characteristics, including DAC metadata.

Prior to interacting with the current subject matter, the Sender can choose to create new credentials for the DA being exchanged. The Sender can submit supporting information for the attestation to the current subject matter and can specify conditions under which the DA may be opened. The resulting DAC can be packaged and can be returned to the Sender along with a unique identifier that can be used to track the DAC at the current subject matter. The Sender can be responsible for distributing the DAC to any Recipient. Only a Recipient capable of presenting the criteria used for packaging the DAC can retrieve the DA stored within. As multiple DAs can be within the same DAC, each DA can use the same or different criteria such that one or multiple Recipients can access and reassign the DA.

Criteria used for each DA can be specified at the level of the DAC holding, the DACH, and alternative criteria can be used in clearing a DACH. For example, location (latitude/longitude, geo-fence, geo-grid), time of day, network address, device network card address, shared password, payment, or secret.

With respect to Sender is Unknown To Current Subject Matter, this example can behave much like when the Sender and Recipient are Unknown To Current Subject Matter, with the exception that the Sender can have the ability to identify one or more intended credentialed Recipients and can use those credentials explicitly in specifying the conditions under which the Clearing Services can provide access to the DACH.

With respect to Recipient is Unknown To Current Subject Matter, this example can behave much like when the Sender is Unknown To Current Subject Matter, with the exception that the Sender may be unable to identify one or more intended credentialed Recipients and may need to, instead resort to, for example, methods of authorization mentioned with respect to when the Sender and Recipient are Unknown To Current Subject Matter, including geolocation characteristics or shared keys.

With respect to Articulation of DAC Sender's Use of an Intermediary (If Applicable), in each scenario of known or unknown identity, the current subject matter can be responsible for publishing content on behalf of the Sender and the DAC Clearing Service or DAC Clearing Service Network (e.g., as in distributed implementations) activity can be coordinated with Sender specifications for access to DAC holdings, such that content access policies can be applicable given a request to access the content. The Sender and the Recipient may not need to have a dynamic link that can establish a fixed relationship for the current subject matter to associate the end-user performing a DAC access request with the Sender of the DAC in the clearing mechanism.

An intermediary can work on behalf of the Sender, for example, to refine criteria or specifically permit access to a DACH of a DAC, and it can be possible for such a party to do so by, for example, in the case of a known Sender, allowing the Sender to delegate authority to another identified user of the current subject matter. In the case of an unknown Sender, the intermediary can use the unique tracking identifier provided to the Sender at the time of DAC Generation.

With respect to processing a request to the holding of a DAC, the current subject matter has a mode for servicing Recipients with credentials identified by the System and a mode for Recipients who are not identified using specific credentials.

The DAC Clearing Service mechanism can service a request, and the Recipient's credentials can be resolved to a user, smart contract, Oracle and/or other identity reference in the System. The DAC metadata submitted with the encrypted DAC holding can be used to identify the DAC reference and the conditions for access that have been specified by the Sender. Matching for an association between a DAC recipient and DAC for the purpose of unlocking the contents of a DAC holding can proceed in the following manner: 1) A specific relationship between the Recipient and the DAC can be sought, whereby the Sender (if identifiable to the System) of the DAC may be referenced in assisting the processing. 2) On condition of an explicit relationship between the Recipient and conditions by which the Sender specified access to the container, the DAC Clearing Service mechanism can return authorization for the content to be unlocked. 3) When an optional condition for access is met, the DAC Clearing Service mechanism can return authorization for the content to be unlocked.

With respect to Processing a Request to the Holding of a DAC from an Unidentified Recipient, when the DAC Clearing Service mechanism services a request, the requesting user credentials may not be available for presentation. In this case, the clearing mechanism can communicate back to the Recipient's trusted Client application or process. Upon identification of a clearing condition specifying a shared secret (e.g.: a password), the Client process can prompt the Recipient to supply additional information for the purpose of clearing. Application context, including location of the Recipient's originating transaction can be passed to the clearing mechanism. If an explicit condition is detected by which clearing should occur, the mechanism can provide authorization for the request to result in the content being unlocked.

With respect to Sender Disables the DAC or Relationship with identified Recipient, the DAC can become compromised, lost, stolen, and/or the like. In this case, the DAC can be disabled by the Sender, or an intermediary knowing its unique identifier provided at the time of generation. All requests to a disabled DAC can be traced to origin for subsequent audit; the DA may not be compromised or capable of being subsequently accessed. In the case of a Recipient that has been identified explicitly, a Sender can disable DACs they issue with respect to that Recipient specifically, pending reactivation of the relationship, without generally disabling other DACs that may be in their possession.

With respect to Articulation of DAC Sender Preferences, the Current subject matter has facilities that can provide the Sender of a DAC the ability to specify conditions under which the DAC may be accessed. These preferences can serve as a default for all DACs generated on that identified Sender's behalf. Preferences can include requests for email notification or the ability to dynamically authorize the request for access to content in cases where the Recipient cannot be explicitly identifiable by predetermined specification of the DAC or the current subject matter.

Both Identified and Unidentified Senders can have the ability to specify terms for the intended Recipient. For example, they can specify, characteristics of user's credentials, if the Recipient can be known to the System or Sender, the location of the Recipient (eg: by specifying an address, latitude/longitude, geo-grid, geo-fence, domain, cryptocurrency blockchain), the time at which the Recipient can access the DA from the DAC, a shared secret (e.g.: a password), and/or other criteria for which the deployed current subject matter can be customized.

With respect to Components for the Distributed Packaging, Issuing, Clearing, Accessing, and Managing DA Assignment Transactions, the operational components of this system can be: DAC Generation Service/Issuing Service; DAC Clearing Service; DAC Client; and DAC Management Environment.

Independent of the components of this system, the current subject matter can rely on, for example, a system of network traffic proxies, VPNs, and open solutions such as TOR (the Onion Router) to anonymize network activity of DAC Senders and Recipients from external observation. Furthermore, it can also rely on a system of intrusion detection devices and active monitoring devices for the purpose of securing the internal network operations or components around core components of the current subject matter.

As discussed above, control of content access can be specified statically or dynamically. The current subject matter can decouple the specification of for example, Sender preferences, end-user/system/process credentials, and encrypted content, such that they can be used dynamically and flexibly in runtime, and can enforce access privileges specified by DAC Senders with respect to the criteria for receipt of DAs.

The current subject matter can make use of network and data level security, for example, Public Key infrastructure and key exchange, to prevent message interception and fraud. The application of these techniques can be substituted with other approaches for identity-based cryptographic processes. Components can be authorized using public key signatures and communication between and/or of services can occur using encrypted data wrapped by SSL protocol. In the case of the DAC Client, code signing techniques can be used to ensure that an end user cannot be provided with an opportunity to manipulate the system. For example, the user or process-facing client to the sending and receipt of DAC may not be tampered with at an endpoint.

The DAC is built by a DAC Generation Service that can have an address for, and/or one or more public credentials of, one or more DAC Clearing Services that can process a DAC access request made by a DAC Recipient, as part of an asymmetric encryption or verification process. In a centralized implementation these public credentials may be public keys, or shared keys of the Clearing Services network. The DAC Clearing Services can possess one or more Public Keys associated with one or more DAC Generation Services, and can determine if components of a DAC requested for access have not been tampered with. As such, the DAC Issuing Authority and DAC Clearing Service can be decoupled components of the current subject matter that can be hosted by different entities. The holdings of a DAC can be resolved at different DAC Clearing Services. Similarly, a DAC Clearing Service can be configured to clear DACs originating from one or more DAC Generation Service.

Trust between components can be desired for the system to work. Keys can be exchanged between components and can be trusted because they can be issued by the same Certificate Authority. Or they can be issued by other conventional mechanisms by which trust in key exchange can be maintained (e.g. using trusted third parties or public certificate authorities).

With respect to DAC Generation Service/Issuing Service, the current subject matter can use a mechanism for packaging that can be referred to as the DAC Generation Service. The party packaging the DAC can ensure that the content supporting each Digital Attestation added to the DAC can represent a legitimate and verifiable attestation for the purpose of end user or process consumption. The Sender can use the DAC Client to facilitate ease of this type of manipulation and assignment.

In some cases, a DAC can be packaged by an intermediary, whereby the intermediary can package DAs from multiple Senders. In this case, the intermediary can be known as a Sender Intermediary. The resulting DAC can contain multiple DACHs whereby each DACH may reference the digital attestations of multiple independent smart contracts or Oracles. Where a recipient of the DAC cannot be the immediate Recipient, but is responsible for the retransmission or alternative movement (e.g.: via removable storage, USB drive, email, and/or the like) to an intended recipient, this party can be called a Recipient Intermediary. A single Sender can similarly package multiple DAs having different intended Recipients within the same DAC.

Packaged DACs can have unique identifiers that allow them the potential to be tracked, logged, and/or audited. In one implementation, the DAC Generation Service can verify the known status of attestations presented for inclusion in the DAC and/or can ensure authoritative ownership of the DA Sender. The Sender of a DAC can establish an agreement with the current subject matter whereby the current subject matter can act on behalf of the Sender in retrieving and packaging the data associated with the DAC in a single atomic operation. For example, in the case of the Sender as a smart contract seeking attestation to the result of an Oracle, where instead of the smart contract querying the Oracle directly, the smart contract may use its Trusted Client to send a proxied request for data to the Oracle and, therefore, directly receive the Oracle's response in the form of a DAC. This DAC can be used for subsequent processing by the smart contract, and/or distribution and/or storage, as can be desired by the smart contract's constituents. In this proxy relationship, the current subject matter can have the potential to shroud or otherwise anonymize the inquiry of the smart contract. Proxies can be specialized for communication with specific types of Oracles (e.g. financial Oracles, weather Oracles, etc. . . . ) and packaging of content from different classes of content. These proxies can register themselves subsequently for the purpose of developing reputation with the smart contract community, and can potentially charge for their inclusion and use with conventional smart contract authoring techniques.

With respect to DAC Clearing Service, using the DAC format discussed above, and the structures discussed above, the current subject matter can facilitate authorization to rights managed content, for example, by: Considering the presented credentials or context to identify the Recipient; and, Using presented credentials to identify preferences that exist for that Recipient's behavior in the system through a directly articulated relationship with the DAC specified by the Sender, or, in the case of a Recipient who does not have credentials, through alternative parameters that have been submitted as part of the Recipient's request context in session with the DAC Clearing Services. Using this mechanism, a Recipient user can be authorized to access content on the basis of either explicit permission by the Sender or through the fulfillment of authorization criteria established for the DAC at the time it was issued.

The DAC Clearing Services can use, for example, a plurality of private/public keys for the purpose of issuing different vintages or strengths of DAC. These keys can be randomly and/or specifically assigned for use during the DAC Generation Service process, and/or on the basis of required strength or surety. Keys can be used by the DAC Clearing Services, and can be stored using, for example, a hardware cryptographic system, in a computer file system, on network, in memory, or trusted execution environment (e.g., as an embedded environment for execution apart from a rich operating system environment). In the case of both centralized and decentralized implementations, multi-key cryptography and/or identity-based encryption can be used.

The DAC Clearing Services can be further characterized by integrated messaging and notification systems, such that access requests may be communicated via for example, an online message center, email, SMS, interactive voice response system or other modes of end user communication. This integration can allow for ambiguous requests from potential recipients to be vetted and authorized by a potential Sender in real-time, and the requirements for facilitating this communication can be met by the Sender in, for example, an identified or unidentifiable context. For example, a Sender with an account with the System could have an email address or a mobile phone number on record to permit this activity, whereas an anonymous user with the system may provide a phone number or email address at the time of DAC packaging to facilitate interactivity at the time of clearing. A Sender can also have preference for how they are contacted, for example, the Sender can choose different mobile phone numbers and/or email addresses depending on the DAC being accessed, the holding of the DAC being accessed, or the Recipient requesting access. Alerts and notifications can be posted to, for example, an identified message queue and/or distributed ledger (e.g. blockchain), such that other automated actors can observe and act upon messages that are generated.

The DAC Clearing Services can log transaction history of each DAC with varying levels of granularity. In cases where an issued DAC can be unlogged, this preference can be specified by the Sender, irrevocably, or turned on/off by the Sender and/or their Intermediary as part of their control settings over the DAC. Transaction logging can be configurable at the DACH level. This configuration can be specified as a function of the rights management specification used at the time of packaging, but can also be customized by interaction with the class of DAC Clearing Services engaged when the DAC is accessed. It is anticipated that a Sender can specify a baseline accountability from the DAC Clearing Services with respect to logging and notification, as part of the contract by which the structure of the DAC is articulated. For example, in the case of a specific DAC that is used to enforce compliance with known regulations, the DAC Clearing Services deployment may be required to keep a mandatory activity log, in which case Sender flexibility in enabling or disabling these options are limited.

The DAC Clearing Services can be seated behind an obfuscated address and/or on a different network from standard DA activity. Only the DAC Trusted Client can need to interact with both the DAC Clearing Services, although additional processing features added to the DAC Clearing Services can lead to direct interaction between the DAC Clearing Services the DA network. The DAC Clearing Services can be known to the DAC Generation Services and specified at the time of packaging, thus it can also be hosted in an environment that can be trusted by the DA Sender.

At a high level, the clearing process can, for example, proceed as follows: 1) The client DAC Trusted Client can present information about itself and the Recipient's context, demonstrating that the DAC Trusted Client has not been tampered with and is a valid application for participating in a Trusted Client transaction. If it is determined the Trusted Client connection is safe for communication, the DAC Clearing Services can negotiate a session key for the communication of secured data. 2) The Recipient's DAC Trusted Client can send the encrypted DACH, application context (e.g.: computer location, and/or the like) and Recipient credentials (e.g. user credentials, pre-established clearing password, and/or the like) to the DAC Clearing Services where the credentials can be verified and on the basis of articulated application logic, the contents of the DACH can either be: a) decrypted and encrypted for communication back to the Recipient using the negotiated session keys, providing restricted assignment of the DACH within the scope of the DAC Trusted Client's session with the DAC Clearing Service; or, b) not decrypted and the Recipient Client is notified of failure of the decryption process on the basis of either poor credentials, unverifiable digital signature on the encrypted content holding, or application logic provided for controlling/overriding DAC Clearing Service processing behavior. 3) If decrypted for the Recipient, the DAC Clearing Service can be assured that the Trusted Client has control over how the Recipient manipulates the data retrieved, such that it cannot be further redistributed without the protections and audit provided by the DAC.

With respect to DAC Transaction Safety for Sender and Recipient, the current subject matter can manage grievances associated with such issues between Sender and Recipient, for example, by offering opportunities to contract for errors and omissions insurance in support of the Digital Attestation being provided to transactions.

With respect to Multi-tiered Clearing Mechanism that Preserves the Anonymity of Sender and Recipient, the DAC Clearing Services can act as a proxy for approval logic hosted by another party capable of identifying the intended Recipient on, for example, the basis of credentials, context (e.g.: location, time of day, and/or the like), and/or other information that can be submitted at the time the request to clear the DACH can be issued. In this case, the DAC Clearing Services receiving the request can be provided with information and configured such that it can be capable of forwarding the request it receives to another DAC Clearing Service and/or alternative service trusted for processing similar Recipient requests. Such forwarded request can occur over, for example, a network used for server-to-server communication. The communication that occurs can happen as, for example, a Service-oriented request (e.g.: SOAP, REST, by remote API, procedure call, and/or the like). In some implementations, service requests can happen over, for example, a TCP/IP network and can use a REST-based API set of calls via HTTPS.

While a Recipient may be unknown to DAC Clearing Services that can be used for issuing the DAC, credentials or context presented by the Recipient can be cleared at an alternative location. This can allow the DA to be similarly accessed, for example, without the custodian of the primary DAC Clearing Service having full understanding of the determination logic being used for processing. Messages passed between DAC Clearing Services and/or a DAC Clearing Service process and an Authorizing service can be secured using, for example, public key cryptography and/or similar techniques, where public keys can be exchanged and trust for authoritative determination of message content can be established.

With respect to Support for Verification Requests, the DAC Clearing Services can provides an interface to support verification requests. It can then be possible for anyone in possession of a DAC to verify that the DAC is authentic and signatures from the DAC Generation Services can indicate that the DAC cannot have been tampered with from the time of original issuance.

With respect to DAC Trusted Client, the DAC Trusted Client can communicate context for the DAC Clearing Services to perform their functions. In some implementations, for example, other software offerings and/or components can be developed and trusted by the DAC Clearing Services. For example, the DAC Clearing Services may not know the party attempting to clear, meaning that the DAC can be presented using context, including, for example, an agreed geography, financial payment, or password that can be used to determine authorization. The Trusted Client can provide support for the trusted communication of this context back to the DAC Clearing Services, in a way that the DAC Clearing Services can know that the data cannot be tampered with. In other cases, credentialed Recipients can clear using biometric credentials that can be collected by the DAC Trusted Client and can be transmitted back to the DAC Clearing Services. Time delays over redemption or the application of context can also be used, for example, by the implementation of a time server that can be referenced by the current subject matter.

DAC Trusted Client requests can be, for example, geo-fenced or geo-gridded, and can allow for tolerance of requests, such that requests can be restricted to specific geographies. Using this approach, a smart contract can, for example, be coded to only accept authority from an Oracle that can provide attestation within a certain jurisdiction.

DAC Trusted Client requests can be restricted by, for example, requesting device network MAC address or other identifying criteria. Where the Trusted Client can operate on behalf of a smart contract, it can be expected that the DAC access can also be bound to the executing context of a specific distributed ledger (e.g. blockchain). In cases where the intended recipient can be more specifically known, the credentials can include, for example, two factor authentication, identity-based authentication, and/or one time passwords, coordinated using a soft token, hard token, and/or mobile device can also be used.

The DAC Trusted Client can provide the Sender and Receiver with an easy-to-use mechanism for providing interaction with the current subject matter. For the Sender, it can provide an easy point of management from which to submit DA information, or, alternatively, can arrange the proxy-based retrieval of DA Information for submission to the current subject matter for processing. It can provide an interface, for example, programmatically and/or human accessible, to manage the status of DACs that can be pending access by Recipients. It can provide an interface, for example, both programmatically and human accessible, to allow for contextual approval of Recipient requests, and can allow for interactivity between the Sender and the DAC Clearing Services.

For the Recipient, it can provide a point of human and programmatic interaction to claim pending DACs and can assign them to the Recipient's ownership. It can provide a basic security footprint that can ensure only trusted interaction with the DAC Clearing Services, whereby user/system/smart contract credentials, context, and other information can be used to support authorization and access to a received DA. The Trusted Client mechanism can be packaged with registry detection and/or other service verification to ensure the system can be clean of spyware or viruses prior to allowing for the opening of a DAC. Using, for example, whitebox cryptographic techniques, a safe sandbox can be provided for managing Client activities, preventing screen and memory capture from spyware, where spyware and malware on DA Recipient computers can sniff credentials and retrieve private keys.

With respect to DAC Trusted Client Working to Facilitate Smart Contract Role as Recipient to a DAC, a smart contract can act as a Recipient to a DAC. In this case, a smart contract can be responsible for performing an access request for content against the DAC packaged by the System of this Invention. It can do so by using lightweight client code embedded into the smart contract, or can connect using a proxy client to an Oracle that can perform the trusted service of opening the container on its behalf. In the case of using a proxy for access to the container, the smart contract can use a proxy re-encryption or identity-based proxy re-encryption (IBPRE) to ensure that the data being opened on its behalf is secured and not revealed to the proxy.

The contents of the DAC can be revealed to the smart contract by a Recipient who can also be party to the smart contract or a third party serving as an intermediary or arbiter of the smart contract, such as a Publisher or Custodian of the DAC. The DAC can be generated as the result of another smart contract or retrieved/published to the smart contract from one or more Oracles that are recognized authoritative sources for data used by a smart contract in execution.

Sharing a DAC with a smart contract can include writing the DAC to a shared directory or repository that can be accessed by the Recipient or publisher of the DAC, and/or the smart contract, which can be established as the location for the DAC to be accessed at the time of the smart contract's specification. The smart contract can be made to poll the specified location for the DAC until the DAC is available, at which time, the DAC can be opened by the smart contract. The current subject matter can be a provider of these repositories for DAC storage and execution. Alternatively, the DAC can be offered as a response from an Oracle to an inquiry made by a smart contract, in which case, the subsequent storage of the DAC, depending on the need to preserve the DAC for future processing or attestation, cannot be necessary.

During its processing, the smart contract can have the ability to retrieve packaged content from the DAC, including, for example, authenticated characteristics of the packaged data, its provenance, and publisher. These authenticated characteristics are determined as a function of the rights management specification used at the time the DAC is generated.

Information extracted from the container can have the ability to facilitate determinations made by the smart contract, in way that connecting to an Oracle can typically inform a smart contract's execution. Features including, for example, time-based locking of data can be used to enforce the temporal availability of DAC data that can be packaged in advance of a smart contract's request. For example, temporal availability can prevent the use of a specific attestation by a smart contract beyond a specific date. Similarly, other rights management state enforcement can be used by Information Owners and Rights Managers, and can control information available to a smart contract.

The DAC can represent immutable, non-repudable data for the decision making process of a smart contract, and, as such, the DAC can be considered to work as an Oracle to the smart contract, with the benefit of, for example, providing asynchronous attestation to its non-reputable state; this can support an additional notion of availability and/or resilience for the required relationship between the Oracle and the calling blockchain, as the Oracle cannot need to be online during smart contract execution, and the Oracle's determinations can be pre-packaged or distributed to a distributed ledger network (e.g. a blockchain network) for access at a later and/or required time.

This mechanism for attestation can additionally allow an Information Owner and/or an Oracle to a blockchain to represent the state or existence of an event on a second (and/or multiple blockchains) to that observing blockchain. In this case, the Oracle can package observed state for consumption by one or more nodes or executing smart contracts of the calling distributed ledger (e.g. blockchain) in the form of a DAC, where each node can be a potential Recipient.

With respect to DAC trusted client working to facilitate smart contract role as Sender of a DAC, a smart contract can be pre-programmed to generate data as result of execution on a public and/or private blockchain. In so doing, the smart contract can rely on one or more Oracles to validate the terms of its execution. The execution of the smart contract can imply that the conditions required can have been met, as reported by its Oracles. A notarized receipt of Oracle state can be received and/or validated, and can support the smart contract execution.

In the case of a smart contract working as a Sender of a DAC, the result of Oracle requests can be collected and packaged as a DAC that can represent a receipt to the smart contract's execution. A unique identifier of the resulting DAC can be embedded into the calling blockchain and the DAC can be forwarded through the execution of the smart contract to interested parties in the smart contract's execution. In so doing, the results of the smart contract execution cannot need to be memorialized to the calling blockchain for the interested parties in a smart contract to be certain to the attestation of its outcome.

Permissions on the resulting container can be specified as part of the smart contract. As a matter of practicality, these DAC-based receipts can be used to memorize and attest to the outcome of smart contract decisions. A smart contract, acting as the Sender of the DAC, can trigger behavioral changes associated with the disclosure of DAC's holding contents. In this case, the Information Owner or generating smart contract can identify the credentials of another smart contract that can subsequently access and modify the clearing behavior of the DAC, for example, as it is received by another smart contract or other Recipient.

Using a smart contract enabled behavior whereby the smart contract packages and publishes data as a DAC can serve as an advantage to generally publishing to an alternate blockchain, as participants of that blockchain can monitor the publication of the event as a, for example, likelihood event that the supporting smart contract either failed or succeeded. By contrast, the use of a DAC for storing this data can be privacy preserving with respect to both the result and the status of the event being journaled.

With respect to DAC Management Environment, the DAC Management Environment can be a set of deployed services that can be accessed by either desktop or mobile device, but similarly can have potential to work with, for example, interactive voice response (IVR) and/or other technology interfaces, and can provide tooling for the Sending, Receipt, Management, and/or Control of DAC transactions. The DAC Management Environment can also operate as a client to a distributed ledger, and/or blockchain. The DAC Management Environment can be deployed by itself or with the whole current subject matter. In singular deployment it can be able to connect with, for example, the hosted components of other DAC Generation and Clearing environments.

In some implementations, roles that can be supported by the DAC Environment interface can, for example, include: DA Sender (e.g., a party using the current subject matter to distribute DA in the DAC format); DA Recipient (e.g., a party using the current subject matter to receive DA in the DAC format). Other roles can be easily added to the system, such that, for example, certain functions of the DAC current subject matter are exposed for conventional use.

Features of the current subject matter can, for example, include: An internal notification and messaging system for securely notifying credentialed Senders and Receivers of active/pending/completed/suspended/rejected DAC transactions, including those generated as a result of the DAC Generation Service or DAC Clearing Service activity; A DA submission system for providing workflow to enable DA Senders to send DAs to either specified or unspecified recipients, including: the ability to specify the format of the DA; the ability to add/remove an additional DA to the same DAC that is pending construction; the ability to search identifiable Recipients from a public directory hosted by the current subject matter; the ability to specify Recipients using an address associated with their account that is hosted by the current subject matter; the ability to specify qualifying criteria that an intended Recipient must meet prior to receiving access, including a location from where the intended Recipient may claim the DA packaged in the DAC, times/dates when a request may be considered acceptable, shared secrets (e.g.: shared passwords) to facilitate DA retrieval, or the desire for interactive notification and approval of a DA access request; the ability to specify levels of transaction monitoring and logging for issued DACs; and the ability to see and monitor access to issued DACs, and render them or relationships with intended recipients inactive.

The DAC Management Environment, in some implementations, can be a high-assurance web based environment that can be segregated into tiers for processing, but can also be flexible hosting if a public-facing implementation be required. Calls back to other components can be performed using a secure servicer-oriented architecture. The DAC Management Environment can be stateless and can be scaled across multiple servers for ease of meeting performance goals.

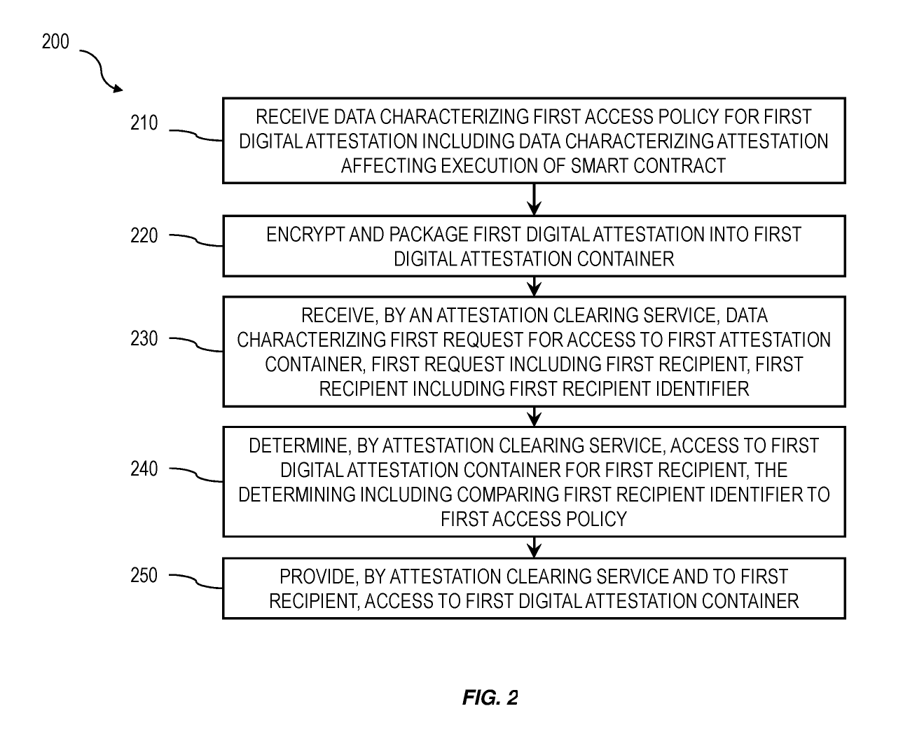

FIG. 2 is a process flow diagram illustrating a method in accordance with the current subject matter. At 210, data can be received by a building service (e.g., a packaging service). The data can characterize a first access policy for a first digital attestation. The first digital attestation can include data characterizing an attestation. The attestation can affect an execution of a smart contract.

At 220, the building service can encrypt and package the first digital attestation. The first digital attestation can be encrypted and packaged into a first digital attestation container. In some implementations, encrypting and packaging can be performed by another entity, such as a packaging or building service, which can be independent of the attestation clearing service. Other entities are possible. At 230, data can be received by the attestation clearing service. The data can characterize a first request for access to the first digital attestation container. The first request can include a first recipient. The first recipient can include a first recipient identifier. Content can be received directly and/or indirectly from different entities, including the sender.

At 240, the attestation clearing service can determine access to the first digital attestation container for the first recipient. The determining can include comparing the first recipient identifier to the first access policy. At 250, the attestation clearing service can provide access to the first recipient. The provided access can include access to the first digital attestation container.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a first access policy for a first digital attestation including data characterizing an attestation affecting an execution of a smart contract;
encrypting and packaging the first digital attestation into a first digital attestation container;
receiving, by an attestation clearing service, data characterizing a first request for access to the first digital attestation container, the first request including a first recipient, the first recipient including a first recipient identifier;
determining, by the attestation clearing service, access to the first digital attestation container for the first recipient, the determining including comparing the first recipient identifier to the first access policy; and
providing, by the attestation clearing service and to the first recipient, access to the first digital attestation container.

2. The method of claim 1 further comprising:
receiving, by the attestation clearing service, data characterizing a first smart contract transaction;
encrypting, by the attestation clearing service, and packaging the first smart contract transaction into the first digital attestation container;
generating, by the attestation clearing service, a first decryption symmetric key for decrypting the first digital attestation container; and
providing, by the attestation clearing service, the first decryption symmetric key.

3. The method of claim 2, wherein the encrypting and packaging of the first smart contract transaction includes utilizing a public credential of the attestation clearing service.

4. The method of claim 2, wherein the smart contract includes a transaction protocol that executes at least one term of a contract.

5. The method of claim 1, wherein the first digital attestation container includes a digital cryptocurrency unit of exchange, a metadata, an associated cryptocurrency address, a keys, a structured data, and/or an unstructured data.

6. The method of claim 1, wherein the first access policy includes data characterizing an authorization criteria for access to the first digital attestation container.

7. The method of claim 5, wherein the authorization criteria includes a user context, an execution context, an application context, a data context, a passcode, a claim id, a geo-fenced location of attempted access, and/or a geo-grided location of attempted access.

8. The method of claim 1, wherein the attestation clearing service includes a decentralized clearing environment including a plurality of clearing machines configured to determine access to the first digital attestation container, the determining including a coordinated consensus between the plurality of clearing machines.

9. The method of claim 1, wherein the attestation includes bearing witness, confirming, authenticating, validating, verifying, and/or documenting.

10. A system comprising:
a building service configured to perform operations comprising:
receiving data characterizing a first access policy for a first digital attestation including data characterizing an attestation affecting an execution of a smart contract; and
encrypting and packaging the first digital attestation into a first digital attestation container; and
an attestation clearing service configured to perform operations comprising:
receiving data characterizing a first request for access to the first digital attestation container, the first request including a first recipient, the first recipient including a first recipient identifier;
determining access to the first digital attestation container for the first recipient, the determining including comparing the first recipient identifier to the first access policy; and
providing to the first recipient, access to the first digital attestation container.

11. The system of claim 10, wherein the attestation clearing service is further configured to perform operations comprising:
receiving, by the attestation clearing service, data characterizing a first smart contract transaction;
encrypting, by the attestation clearing service, and packaging the first smart contract transaction into the first digital attestation container;
generating, by the attestation clearing service, a first decryption symmetric key for decrypting the first digital attestation container; and
providing, by the attestation clearing service, the first decryption symmetric key.

12. The system of claim 11, wherein the encrypting and packaging of the first smart contract transaction includes utilizing a public credential of the attestation clearing service.

13. The system of claim 11, wherein the smart contract includes a transaction protocol that executes at least one term of a contract.

14. The system of claim 10, wherein the first digital attestation container includes a digital cryptocurrency unit of exchange, a metadata, an associated cryptocurrency address, a keys, a structured data, and/or an unstructured data.

15. The system of claim 10, wherein the first access policy includes data characterizing an authorization criteria for access to the first digital attestation container.

16. The system of claim 10, wherein the attestation clearing service includes a decentralized clearing environment including a plurality of clearing machines configured to determine access to the first digital attestation container, the determining including a coordinated consensus between the plurality of clearing machines.

17. The system of claim 10, wherein the attestation includes bearing witness, confirming, authenticating, validating, verifying, and/or documenting.

18. A computer program product comprising a non-transitory machine readable medium storing instructions that, when executed by at least one programmable processor, cause the at least one programmable processor to perform operations comprising:
receiving data characterizing a first access policy for a first digital attestation including data characterizing an attestation affecting an execution of a smart contract;
encrypting and packaging the first digital attestation into a first digital attestation container;
receiving data characterizing a first request for access to the first digital attestation container, the first request including a first recipient, the first recipient including a first recipient identifier;
determining access to the first digital attestation container for the first recipient, the determining including comparing the first recipient identifier to the first access policy; and
providing, to the first recipient, access to the first digital attestation container.

19. The computer program product of claim 18, further comprising:
receiving data characterizing a first smart contract transaction;
encrypting and packaging the first smart contract transaction into the first digital attestation container;
generating a first decryption symmetric key for decrypting the first digital attestation container; and
providing the first decryption symmetric key.

20. The computer program product of claim 19, wherein the smart contract includes a transaction protocol that executes at least one term of a contract.
